(19) United States
(12) Patent Application Publication
(10) Pub. No.: US 2006/0080178 A1
(43) Pub. Date: Apr. 13, 2006

(54) Method for serving picture images on the internet

(76) Inventor: Tae-Yurn Lee, Seongnam (KR)

Correspondence Address: GWIPS;PETER T. KWON, 1600-3 SEOCHO-DONG, SEOCHO-GU,, DAELIM BUILDING, 9TH FLOOR, SEOUL, 137-877, KR

(21) Appl. No.: 10/537,225

(22) PCT Filed: Dec. 6, 2003
(86) PCT No.: PCT/KR03/02675

§ 371 Date: Jun. 2, 2005

(30) Foreign Application Priority Data
Dec. 6, 2002 (KR) 10-2002-0077335

(51) Int. Cl. G06Q 30/00

(52) U.S. Cl. 705/26

(57) ABSTRACT

The present invention relates to an improved method for serving picture images on the internet based on a different method, and in particular to an improved method for serving picture images on the internet which is capable of selling picture images for an increased price based on an anti-discount service method with respect to images having a high use frequency by determining a sale sequence of images, and when using the picture images, a place of use, a start date of use, and serial number of images are reported to an operator of a web site.

### TECHNICAL FIELD

The present invention relates to an improved method for serving picture images on the internet based on a different method, and in particular to an improved method for serving picture images on the internet which is capable of selling picture images for an increased price based on an anti-discount service method with respect to images having a high use frequency by determining a sale sequence of images, and when using the picture images, a place of use, a start date of use, and serial number of images are reported to an operator of a web site.

### BACKGROUND ART

Pictures images are used for a TV broadcasting ID fabrication image or bridge image, an AD fabrication image, a homepage content, a music video image, a DVD image, a movie, a product packing paper, a cover page image of a novel, a magazine, and poet book, and various printing materials of a textbook, an encyclopedia, a poster, etc.

The conventional picture images including motion pictures are rent in a library form for the use of images, and are fabricated in a DVD, CD, tape and printing material and are sold. Recently, the picture images are converted into a digital image at a low cost and are sold on the Internet.

Namely, as the prior art related to the present invention are the Korean patent registration application No. 2000-56649 (Laid-open No. 2002-24858) (picture processing service providing system using the Internet and method of the same), the Korean patent registration application No. 2001-5749 (Laid-open No. 2001-44322) (System and service concerning online development of digital pictures and images), and the Korean patent registration application No. 2002-42820 (Laid-open No. 2002-67024) (Online photo service based on digital edit and system of the same).

However, in the conventional technology, various picture images are provided during a certain period and are used in various fields. Therefore, it is expected that the prices of the picture images are high, but on the contrary, the actually transacted prices are low because it is told that a scarcity value is decreased. In other words, to the customer side, it is helpful and it is preferred that the prices of the picture images are decreased when the same picture images are frequently used by the companies in the same field.

In detail, if the artistic value of the picture images are high, and the demand is also high, it is expected that the prices of such picture images are increased, but the prices are decreased because such picture images are more frequently used based on the higher demand. Therefore, to the author of the picture images, a creation desire may be decreased.

In addition, in the conventional art, when providing the services concerning the picture images, the use of place, a start date of use, a serial number of image, etc. are not reported to the operator of the web site, so that a large amount of illegally copied picture images may be used for thereby infringing the copyrights.

### DISCLOSURE OF INVENTION

Accordingly, it is an object of the present invention to overcome the problems of the conventional art.

It is a first object of the present invention to provide an improved method for serving picture images on the Internet based on a different method in which a certain amount of picture images is downloaded at a very low cost with respect to a charged member by displaying various fields of pictures by their categories on an Internet homepage.

It is a second object of the present invention to provide an improved method for serving picture images on the Internet based on a different method capable of providing images based on an anti-discount service method by determining a popular sequence for a certain period based on the number of uses and increasing the prices of the images included within a certain rank.

It is a third object of the present invention to provide an improved method for serving picture images on the Internet based on a different method in which a user reports the place of use of the images, a start date of use, a serial number of images, etc. to the operator of the web site.

It is a fourth object of the present invention to provide an improved method for serving picture images on the internet based on a different method capable of significantly enhancing a user's convenience and reliability in such a manner that a user selects in real time a desired picture image on the Internet.

To achieve the above objects, in a method in which a plurality of picture images in various fields are stored in an internet homepage, and a user is connected with the homepage and logs in and receives a service of a picture image, there is provided an improved method for serving picture images, comprising a step in which an operator of a homepage determines an image-based sale rank based on the number of uses of the picture images (sale rank) during a certain period in a process that the picture images are downloaded, and a step in which the operator of the homepage opens the sale rank on a bulletin board or a notice section of the homepage, and the prices of the picture images are increased with respect to the images having a high frequency of uses by the users based on an anti-discount service method.

### BRIEF DESCRIPTION OF DRAWINGS

The present invention will become better understood with reference to the accompanying drawings which are given only by way of illustration and thus are not limitative of the present invention, wherein;

FIG. 1 is a view for describing a method for serving picture images on the Internet based on a different method according to the present invention;

FIG. 2 is a flow chart of a method for serving picture images on the Internet based on a different method according to the present invention; and

FIGS. 3A through 3F are views illustrating screen windows of an Internet homepage according to the present invention, of which:

FIG. 3A is a view illustrating a screen window of a first screen of an Internet homepage;

FIG. 3B is a view illustrating a screen window of a picture photographing technique of an Internet homepage according to the present invention;

FIG. 3C is a view illustrating a log-in screen window of an Internet homepage according to the present invention;

FIG. 3D is a view illustrating an image window and a visit screen window of an Internet homepage according to the present invention;

FIG. 3E is a view illustrating a screen window of an image selection and search of an Internet homepage according to the present invention; and

FIG. 3F is a view illustrating a screen window of an image selection of an Internet homepage according to the present invention.

### BEST MODE FOR CARRYING OUT THE INVENTION

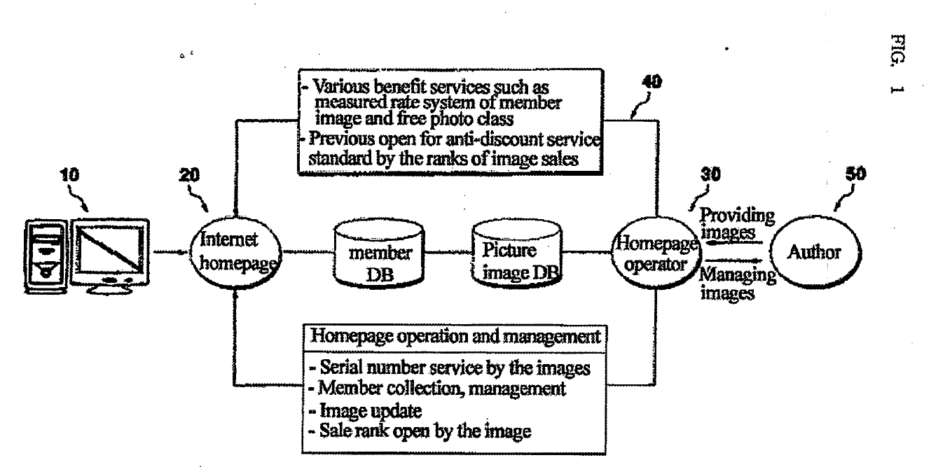

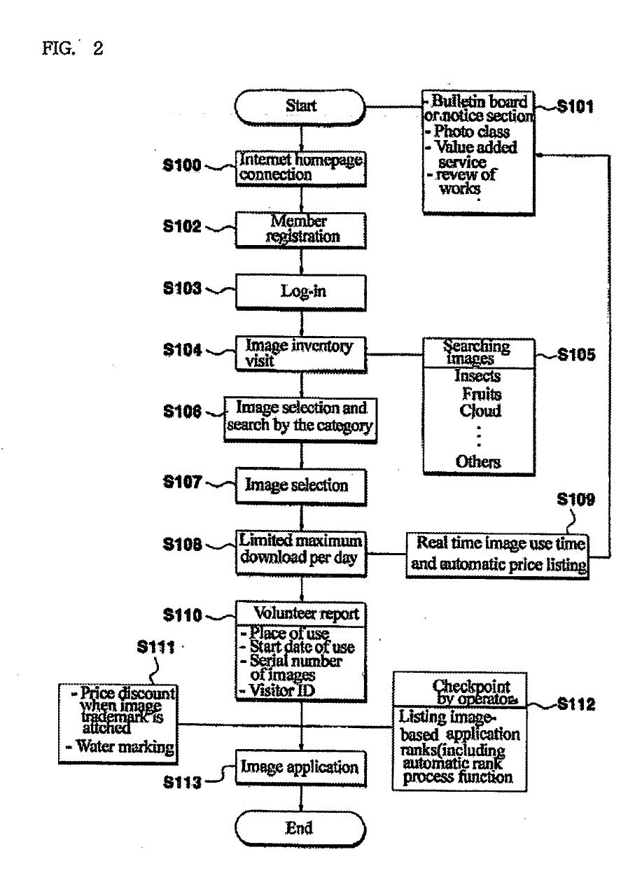

The method for serving picture images on the Internet based on a different method according to the present invention is implemented as shown in FIGS. 1 through 3.

In the following descriptions, in the case that the detailed descriptions concerning the known functions or constructions are seemed to make the gist of the present invention unclear, the detailed descriptions thereof will be omitted.

In addition, the terminologies are set in consideration with the functions disclosed in the present invention. Therefore, the terminologies may be changed based on the manufacture's intention or rules, so that the terminologies must be understood based on the entire contents throughout the specification.

In the present invention, many picture images of various fields are provided in an Internet homepage 20, and a user 10 is connected with the Internet and logs in the Internet and receives the service of the picture images. At this time, the homepage operator 30 manages the member DB and picture image DB using the server 40. The author 50 provides the homepage operator with the images and the homepage operator 30 manages the images received from the author 50.

In the present invention, the homepage operator 30 continuously operates and manages the homepage and provides an image-based serial number (for example, KR001FL002LTY, 01040002, etc.) to the picture images. The homepage operator 30 collects and manages the members and makes a notice concerning the image updates, the image-based sale rank, etc. In addition, the homepage operator 30 provides a notice concerning the value added services such as a measured rate system for the use of images by the user, a free photo class, etc. and concerning an anti-discount measuring standard based on the rank of image sale.

In more detail, in the process that the user downloads the picture images, the homepage operator 30 determined the sale range by the images based on the number of uses of a corresponding picture image, and the homepage operator 30 makes an open on the bulletin board or notice section and increases the prices of the picture images with respect to the images having the high frequency of use based on the anti-discount service method.

In addition, in the process that the picture images are downloaded, the number of the use of the images is automatically indicated. The homepage operator increases the prices of the images based on the number of the uses of the images after a certain period is passed and opens a result of the same on the bulletin board or notice section of the homepage.

In addition, the user reports a start date of use, a place of use, a serial number of images used, and a visitor ID before the images are used.

In the present invention, in the case that a certain trademark of the picture images designated by the operator is used, a certain amount of discount is provided. In addition, in order to prevent an illegal copy, and in order to effectively protect the owner's copyrights and rights of the data, a watermark is provided to all picture images.

In the present invention, the picture images represent a still image, a motion image, a character, a cartoon, a poster, a postage stamp, an animation, a movie, etc. including a digital image product of a printed or stored book or CD, DVD, tape, etc.

In the present invention, when applying the above elements, it may be variously modified and may be remodeled in various types.

In addition, in the present invention, the above construction and operation are not limited thereto.

The method for serving picture images on the Internet based on a different method according to the present invention will be described.

As shown in FIGS. 1,2 and 3A, the user 10 is connected with the Internet homepage 20 (S100).

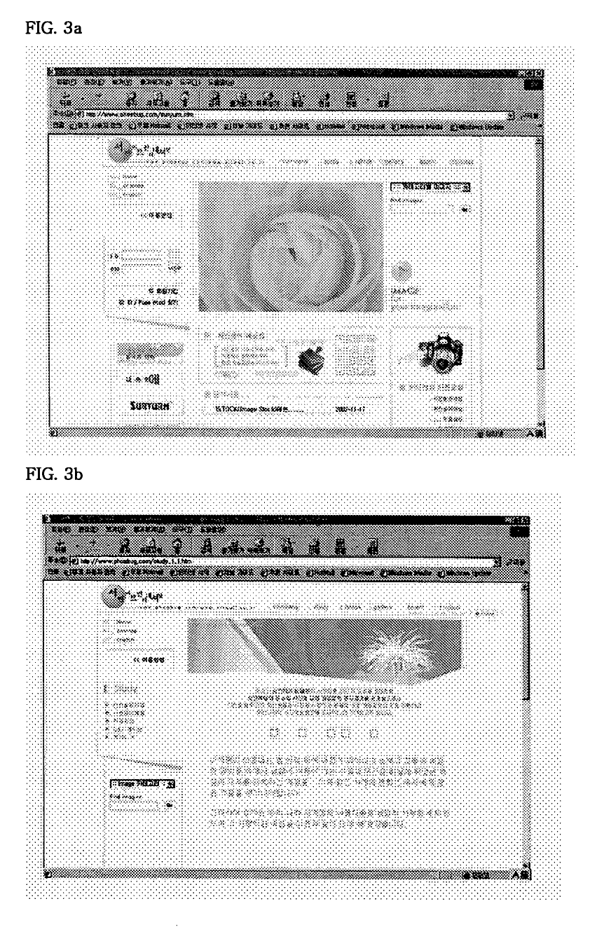

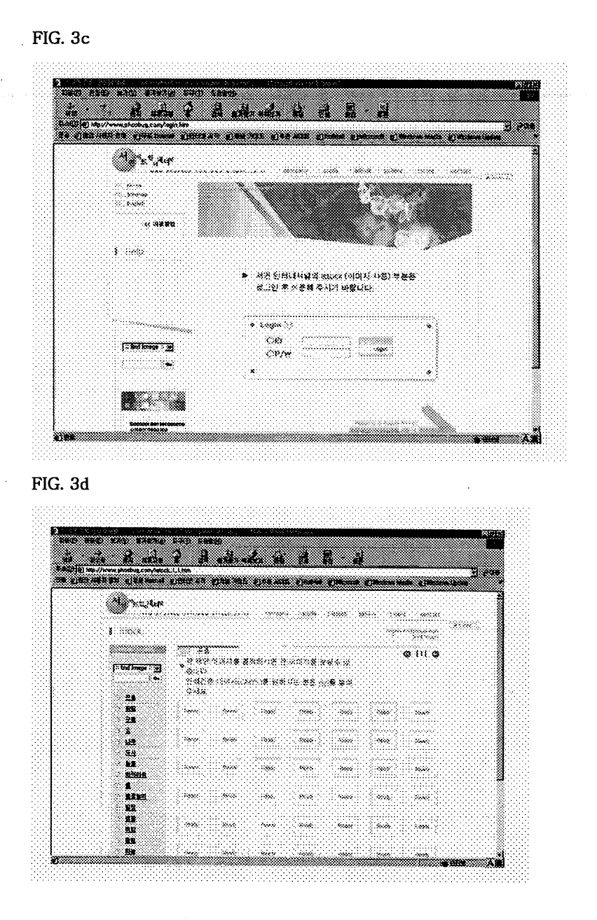

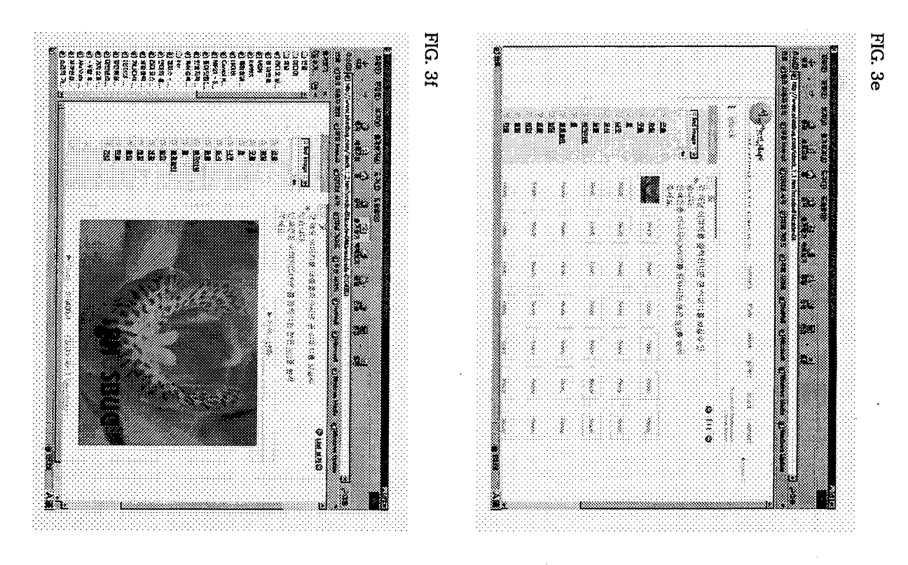

When the user 10 is connected with the internet homepage 20, on the first screen, there are shown a value added service such as a member image measured rate system and a free photo class (FIG. 3B), and a member registration, a bulletin board notice, a work feeling, etc. (S101). The user goes to the next step based on a selected option.

As shown in FIG. 3C, in the above state, the user 10 registers as a member (S102) in order to use the picture images and logs in (S103). Thereafter, a screen window of the image inventory visit (S104) is displayed as shown in FIG. 3D.

Various kinds of images (S105) (for example, insects, fruits, cloud, flowers, trees, cities, animals, magic hour, fire works, buildings, life, sun, tulip, sky, others) are displayed on the image inventory visit (S104). Here, when the user selects the images by the category and searches (S106), as shown in FIG. 3E, an image is shown on a small window. When a corresponding image is double clicked, namely, is selected (S107), it is possible to see a large image as shown in FIG. 3F. At this time, there is provided a description concerning an image-based serial number, a title, a sale price, a purpose of recommendation, and a detailed description in the lower side of the large image.

In the above state, the user can download a desired image (the program used for downloading the image may be programmed to download the images by 5 images per day in maximum). When the images are downloaded, the number of the uses of the images and the prices of the images are automatically displayed in the lower sides of the images (S109). The number of the uses of the images and the prices of the images are provided by the picture image DB in the bulletin board or the notice section (S101). The user can check a result of the same in the bulletin board or the notice section of the Internet homepage 20.

The present invention is directed to adapting the anti-discount service method in which the prices of the picture images are increased (for example, the prices of the sales are increased within a range of 5-15% based on the states of the markets) with respect to the images that are ranked within a certain range (rank 1 through rank 5) by determining the popular images during a certain period (for example, three through six months). The above operation may be well implemented in such a manner that the operator of the homepage provides the above-described contents on the notice section or the bulletin board of the first screen for a certain period when the user visits the Internet homepage.

The user should report a purpose of use, a start date of the use, a serial number of image, and a visitor ID, etc. with respect to the images downloaded by the user to the operator of the homepage through an e-mail (S110). At this time, if the user does not report the above contents, the membership of a corresponding member may be automatically lost. In addition, the member cannot register the homepage 20 as a member for two years. The images used without a report to the operator are recognized as an illegal use of the images. In addition, the period of the use of the images is set to 1 year. In the case that the user wants to extend the period of use, the member should register a member again.

After the user voluntarily reports to the operator (S110), the user actually uses the image (S113). Before the user uses the image (S113), the operator provides the images with a certain trademark designated by the user. The prices for the use of the image are discounted (for example 50% DC) with respect to the user who uses the images with a recognizable trademark (Sill). In particular, a certain trademark or recognizable symbol that is designated by the operator may be inserted into the images based on a watermark method and is recovered when the image is checked to judge whether the image is legal or illegal for thereby effectively protecting the copyrights or rights.

In addition, in the present invention, an operator checking procedure (S112) is provided for performing an imager-based application sequence (for example, automatic sequence processing function) before the image is applied (S113).

### INDUSTRIAL APPLICABILITY

As described above, in the present invention, it is possible to download the picture images by a certain number of sheets per one day at a very low price with respect to the charged members in a state that various kinds of picture images are provided on the Internet homepage by the categories of the images. The picture images are ranked by determining the ranks in the sequences of popular images during a certain period. The prices of the images included in a certain rank range are increased based on the anti-discount service method. The user of the images voluntarily reports a place of use, a start date of use, a serial number of image, etc. to the operator through e-mail and then uses the images. The user is capable of selectively purchasing the images in real time on the Internet, so that it is possible to significantly increase the convenience and reliability of the user.

In addition, the user can select only the necessary images with respect to the digital image products based on a customer-oriented service and can purchase the same on the internet in real time for thereby overcoming the conventional problems that the customer should purchase a few hundreds of images in order to actually use only a few of images. In addition, it is possible to prevent a problem that the user should store the images using many image CDs, diskettes, DVD, etc. after a certain period is passed. Therefore, in the present invention, it is possible to decrease an unnecessary consumption of resource, manpower and budget.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a method in which a plurality of picture images in various fields are stored in an internet homepage, and a user is connected with the homepage and logs in and receives a service of a picture image, an improved method for serving picture images, comprising:
a step in which an operator of a homepage determines an image-based sale rank based on the number of uses of the picture images (sale rank) during a certain period in a process that the picture images are downloaded; and
a step in which the operator of the homepage opens the sale rank on a bulletin board or a notice section of the homepage, and the prices of the picture images are increased with respect to the images having a high frequency of uses by the users based on an anti-discount service method.

2. The method of claim 1, wherein the user of the homepage voluntarily reports a place of use, a start date of use, a serial number of image, and a user ID to the operator of the homepage using e-mail before the start date of the picture images and then uses the downloaded picture images.

3. The method of claim 1, wherein the prices of the picture images are increased based on the frequency of uses of the images after a certain period is passed in a process that the user downloads and uses the picture images, and then the increased prices of the same are open on a bulletin board or a notice section of the homepage.

4. The method of claim 1, wherein when the user attaches a certain trademark or a recognizable symbol designated by the operator to the picture images, the user is provided with a certain benefit.

5. The method of claim 4, wherein said trademark or recognizable symbol is processed in such a manner that the trademark or recognizable symbol is recovered only when it is needed to check whether the picture images are legal or illegal after the trademark or recognizable symbol designated by the operator is provided to the picture images of the homepage operated by the operator using a water mark method.
